(19) United States
(12) Patent Application Publication
(10) Pub. No.: US 2014/0281930 A1
(43) Pub. Date: Sep. 18, 2014

(54) SYSTEM AND METHODS FOR CREATING PRINTOUTS THAT MAY BE MANIPULATED BY MFD

(71) Applicant: FUJI XEROX CO., LTD., Tokyo (JP)

(72) Inventors: Qiong LIU, Cupertino, CA (US); Chunyuan LIAO, San Jose (US)

(73) Assignee: FUJI XEROX CO., LTD., Tokyo (JP)

(21) Appl. No.: 13/841,333

(22) Filed: Mar. 15, 2013

(51) Int. Cl. G06F 17/21

(52) U.S. Cl. CPC G06F 17/212
USPC 715/243

(57) ABSTRACT

A method for a document authoring tool, the method comprising determining a visual feature distribution of a document. The document is modified by redistributing visual features of the document based on the visual feature distribution to create a modified document. A document template is generated from the modified document.

### BACKGROUND

Unnecessary paperwork causes a significant amount of wastage of time. People could use this time for more important work. For example, as US Federal and State governments cut more and more education budgets in recent years, school teachers have less and less time to teach regular classes as well as grade student assignments. On the other hand, paper assignment is still the dominant cost-effective approach for homework, tests, and exams. Compared with paper assignments, digital assignments are much easier for automatic grading. However, digital assignments demand more computer skills that are difficult to achieve for many young students. Moreover, digital assignments require a computer infrastructure that demands additional budget allocation. These demands are not achievable for many schools.

Since paper is still a major media used in our daily life, automating some paperwork with machine may save human time for more important work. In this disclosure, techniques focused on methods for creating MFD operable paper printouts are disclosed.

Similar issues are faced in other fields such as product survey, patient registration, or work environment inspection. To reduce time wasted on paperwork, this disclosure teaches techniques that focus on paperwork automation. To achieve paperwork automation, one important task is to accurately align each printout with its digital version. This process involves printout recognition and geometric alignment. Because multi-function device (MFD) units exist in many schools and companies, MFD paperwork assistant is an exemplary implementation of the techniques discussed in this disclosure. This disclosure focuses on system and methods for creating MFD manipulatable printouts and automating paperwork with MFD.

US20030180703 mainly focuses on an assessment data structure that can facilitate recording student grade, differentiating student performance, and printing assessment on a multifunction device. Compared with this system, the disclosed techniques are focused on how to generate easy to grade assignments without alignment markers, and how to grade students' markers/drawings on these assignments.

US20050255439 focuses on customizing each answer sheet so that the customized answer sheet will not have additional answer areas, sections, or spaces that can confuse an examinee and lead to incorrectly marked answers. Compared with methods and system presented in [3], the present disclosure lets an answer section follows each question directly, therefore does not need to generate and process a separate answer sheet. Moreover, our system does not need any alignment marks to assist the determination of answer sheet boundaries.

US20060257841 focuses on using OCR to recognize equation results and statement answer. After OCR, the user-input character set is compared with the predefined character set for grading. Our grading approach does not use OCR technology at all.

US20060286539 focuses on comparing answers given in affirmative figure shape and negative figure shape. Recognizing affirmative figure and negative figure is not the focus of the present disclosure.

US20080280280 focuses on sharing assessment and creating customized assessment and answer sheet for students. It still uses separated answer sheet similar to a traditional answer sheet while the present disclosure advocate mixing answers and questions for easy reference.

US20090029336 focuses on capturing workflow of a solution. It does not involve any techniques on how to generate and grade paper assignments.

US20090282009 claims a computerized system for assessing electronically-provided constrained constructed responses. It defines some possible drawings for grading. However, it does not provide any details on how to recognize these drawings. Compared with this system, the present disclosure system provides a systematic way for grading drawings based on paper alignment error.

US20100157345 mainly focuses on the configuration of a 2-unit hardware grading system. Compared with that system, our approach mainly claims on software mechanism for using an existing MFD unit. U.S. Pat. No. 7,764,923 is a continuation of publication US20100157345 and it describes methods to recognize text in predefined forms for grading student assignment. Compared with publication, the disclosed teachings do not use fixed form type nor does it depend on text recognition for grading.

### SUMMARY

To realize some of the advantages and to overcome some of the disadvantages disclosed herein, there is provided a method for a document authoring tool, the method comprising determining a visual feature distribution of a document. The document is modified by redistributing visual features of the document based on the visual feature distribution to create a modified document. A document template is generated from the modified document.

In a specific enhancement a marked up copy of the document template is aligned with the document template. A first markup is extracted from the marked up copy of the document template, based on the aligning.

In a more specific enhancement, the marked up copy of the document template is compared to a subsequent marked up copy of the document template.

In an even more specific enhancement, the comparing the marked up copy of the document template to the subsequent marked up copy of the document template comprises aligning the subsequent marked up copy of the document template with the document template, extracting second markup from the subsequent marked up copy of the document template, based on the aligning and comparing the extracted first markup with the extracted second markup.

In an even more specific enhancement, a corrected version of the subsequent marked up copy of the document template is generated by adding visual distinctions on the subsequent marked up copy of the document template, based on the comparing the marked up copy of the document template to the subsequent marked up copy of the document template.

In a further specific enhancement, the redistributing is performed so that the visual features of the document are redistributed uniformly across the document.

In yet another specific enhancement, redistribution is performed so that at least one figure is positioned based on a proximity of the figure to text relevant to the figure.

In still another specific enhancement the visual features of the document are changed so as to further differentiate the document.

In another specific enhancement the document template is used for comparing with a marked up document by a subprocess, including determining locations in the document template where correct markups are expected, receiving a marked up document, aligning the markedup document with the document template, determining markup positions by comparing the marked up document and the document template and making a determination regarding the markups based on the comparison if a percentage threshold of an expected markup is crossed.

In a specific enhancement, the threshold is 50%.

In another specific enhancement, the document template is used for comparing with a marked up document by a subprocess, including identifying a figure in the document template that is required to be compared, receiving a markedup document with a corresponding figure, aligning the markedup document with the document template, and making a decision about the figure based a comparison of the figure in the document template and the corresponding figure in the markedup document.

In a specific enhancement, the determination is based on linear percentage.

In another specific enhancement, the determination is based on an area percentage.

Another aspect of the disclosed teachings is a document authoring tool. The tool comprises an input that receives a document. A visual features redistributor redistributes visual features in the document. A document modifier modifies the document based on the redistributed visual features. A document template generator generates document template based on the modified document and an output.

A computer program product including a non-transitory computing medium, the medium having instructions to enable a computer to implement the above techniques are also part of the method for a document authoring tool.

### BRIEF DESCRIPTION OF THE DRAWINGS

The above and other features and advantages of the present invention will become more apparent by describing in detail exemplary embodiments thereof with reference to the attached drawings in which:

FIG. 1 shows an exemplary MFD Grader Workflow

FIG. 2 shows an example of uniformly distributed matching features making illustrating that it will not be difficult to align a query assignment and an index assignment.

FIG. 3 shows an exemplary procedure for evaluating correct markers in an assignment

FIG. 4 shows illustrations of different grading strategies.

FIG. 5 shows an example of defining a region to find similar drawings in the template.

FIG. 6. Illustration of (a) a traditional test set and (b) an improved test page with the disclosed teachings.

FIG. 7. Shows a flowchart embodying some of the exemplary techniques of the invention.

FIG. 8. Shows a block diagram showing an exemplary apparatus embodying some of the techniques of the disclosed teachings.

### DETAILED DESCRIPTION

FIG. 7 shows a flowchart embodying some of the exemplary techniques of the disclosed teachings. In this exemplary embodiment a document is received in step 701. In step 702 the visual features of the document are determined. In step 703, the document is modified by redistributing the visual features. In step 708, a modified document is created. Finally in step 708, a document template is made based on the modified template.

FIG. 8 shows a block diagram showing an exemplary apparatus embodying some of the techniques of the disclosed teachings. The exemplary apparatus includes an input 801 where a document is received. The input interfaces with a processor 806 and a memory 807. The received document is passed on to the document template generator 802. The Document template generator 802, the Visual feature determiner and redistributor 803 and Document modifier 804 interface with the processor 806 and memory 807. The Document template generator 802 communicates with the Visual features determiner and redistributor 803 and the Document modifier 804. The Document template generator 802 sends the document received at the input 801 to the visual features determiner and redistributor 803. The Visual features determiner and redistributor 803 determines the visual features and redistributes them based on techniques describe further herein below. After redistribution the document modifier 804 modifies the document and sends it back to the document template generator 802. The document template is then output at the output 805. The Output 805 interfaces with the Processor 806 and Memory 807.

The disclosed teachings focus on rearranging the printout layout of the contents to improve alignments between the printouts and their virtual copies without special marker supports. With accurate alignment between printouts and their digital versions, most paperwork can be automated by machines. For example, with a method and/or a system based on the disclosed teachings, school teachers may feed assignments such as homework, tests, and exams to a MFD unit, the MFD unit will adjust layout of these assignments and printout MFD gradable paper version of these assignments for students. After students finish these assignments, a teacher can feed these paper assignments and an assignment solution copy to a MFD unit for automatic grading. The MFD unit will align student-finished copies with the teacher's solution and grade these assignments accordingly. The final grade and feedback will be printed on each student's assignment as well as transmitted to a database for administration purpose or future reference

Printout creation and paperwork automation are the focus of an exemplary implementation according to the disclosed teachings. A school application embodiment is used to explain the disclosed teachings. However, this specific presentation style should not be construed to limit the implementations to school applications only. To people who understand this field well, it will be easy to extend the disclosed techniques to many other applications.

After test scoring machine was invented in the 1930s, standardized quiz or test score sheets have been widely used in schools. However, this technology is still not very convenient for teachers and students to use. First, students need to switch back and forth between quiz content and answer sheet. This context switch process is time consuming, annoying, and error prone. Second after quiz grading, it is hard to figure out what is wrong by just looking at the answer sheet. People still need to go back and forth to figure out where the problem is. Third, it is hard to give students feedbacks with proper contexts. Fourth, test scoring machine is not widely available as part of the functionality offered by MFD which exists in most schools and offices. That makes it a little difficult for teachers and students to access the existing grading systems. Fifth, system that is specialized for grading is much more costly than software extension to existing MFDs.

According to the disclosed teachings, to address the above-noted problems, an MFD system is extended to a test grading system. FIG. 1 illustrates the workflow of a MFD grader. To make a MFD grader working, teachers must feed assignment contents to the MFD grader via network, memory disks, hardcopies, or an assignment database. These contents are then processed by the MFD unit to facilitate its future grading task. This processing may include solution format definition, content layout adjustment, font adjustment, word space adjustment etc. After necessary adjustments, the MFD unit will mass produce paper assignments for students according to the number of demanded copies. Following the completion of these assignments, students can turn in their assignments to the MFD or let their teacher to batch feed their assignments to the MFD. The MFD can then grade these assignments, print final grade and feedbacks on proper space, and transmit grading results to a database for administration and record.

To address the problem caused by separating exam context and answers, according to the disclosed teachings, the answers are positioned just after each related question or problem. It is preferred that some space for grading and feedback to students are provided. Moreover, with more accurate mark position detection, the system can be extended to go beyond multiple-choice format and let students to answer questions with scales or vectors.

Putting answer immediately after each corresponding question gives students more convenience for working on the real problems. However, it creates more problems than standard answer sheet for grading machines. Compared with standard answer sheet, regular assignments have much more variations. These variations make it difficult for a machine to find an expected answer at a certain paper location. To address that problem, the disclosed techniques use visual features to align a MFD scanned paper document with a proper template for answer localization.

If assignment contents are freely arranged by document editor, the output may not be good for paper alignment. For example, if a paper page only has one line or one word, it is hard to identify the original template of this page. Moreover, if all visual features are within a small region, the transformation matrix from a paper page to its original template will not be very stable. To guarantee proper paper alignment with visual features, it is better that the system can properly rearrange available contents for relatively uniform and distinctive visual feature distribution. The simplest approach to achieve this is to adjust line space, word space, and character fonts. For example, after inserting answer sections, the total page length is 8. However, page 8 only has two lines. In this case, the system should change the line space, word space, or font to make the assignment occupy full 7 pages or full 8 pages. Moreover, the system may also move some figures in a certain range near the question to change local features to avoid identical feature occurrences on different pages.

Furthermore, in some instances the figures themselves may be modified to improve alignment or distinguish features without changing the intended content. For example, in case of itemizing objects bullets may be changed to arrows. In other instances, oval boxes that are to be shaded to mark correct answers may be changed to square boxes which can be shaded or marked with a cross “x.” After feature redistribution and verification, the MFD system can output a hard copy for the people to mark correct answers.

After correct answers are marked, the hardcopy with correct answers will be feed to the MFD unit. The MFD unit will align the assignment with correct answers to the originals. FIG. 2 shows matching point of a marked assignment and its original. From this figure, it is clear that markers do not have much impact to the matching. In this process, because the local visual features are evenly distributed on assignment pages, proper alignment of each page with/without question markers will be ensured. This proper alignment will further ensure correct marker extraction. By comparing the image with correct answers with the corresponding image without any answers (e.g. image difference and filtering), the system will extract and save correct marker positions and use this as a base for grading future assignment hardcopy input. FIG. 3 illustrates the procedure of evaluating correct markers in an assignment.

Following the marker position extraction from an assignment solution copy, the MFD will produce student hardcopies according to a requested number. Based on our experiment, we found that the average paper alignment error will be 0.67% of the paper size. That is more than enough for locating a marker. Based on this experimental result, we can also define a possible region and accurate threshold for grading a marker.

Students can work on MFD mass produced hardcopies. After these hardcopies are completed, they can be feed to the MFD unit. The MFD unit will first search a matching template for each hardcopy page and align these completed hardcopies with the matching template. Student markers on each page will then be extracted and compared with correct markers. To compensate alignment errors, grading of these markers can be done in the following way:

If multiple choice type answer markers have more that 50% bubble region pencil marked, the selection is considered made. Then rules for grading can be decided. An example rule for this is that one more or one less choice than the expected will get no credit.

For a number marked on an axis, the center of the marker is first decided. Then a fixed size disk shape is used to limit the pencil trace within the disk shape. A weighting curve anchored to the correct answer can be used to calculate the total pencil trace weight on a student assignment. The measured student pencil trace weight is then divided by the teacher's pencil trace weight to get the score for the number marker. The curve used here can be a Gaussian window, Hamming window, Tukey window etc. This is useful to compensate for paper misalignment. FIG. 4 shows and example for this in one dimension. It may also be used to mark a vector in 2 or more dimensional space.

This system may also be used to grade drawings by detecting pencil marks in certain regions. For example, this can be done for links in a graph or drawings in a map. For this kind of free hand drawings, the system may decide credit or no credit based on the drawing linear/area percentage in a certain region. FIG. 5 shows an example for this.

After the grading of each question, correct answer will be printed on the assignment with different color/shape/pattern. Since the paper assignment is aligned in the MFD, detailed solution can be printed on blank regions for students to review.

FIG. 6 illustrates a traditional exam example and a corresponding exam example built with our methods. Compared with traditional test set, pages generated with our system can have answer sections mixed with the each question section. Because the disclosed approach does not need to encode each answer with a character or number, it may raise the bar for human-human communication related to answers, and thus may reduce cheating behaviors. To extend this advantage further, each question's sequential number like that in FIG. 6 (b) can be removed. Moreover, enabling drawings and markers in proper coordinates may further reduce cheating behavior.

Besides using this system for school assignments, the proposed system may also be considered for surveys, registration automation etc. Considering using cell phone to replace MFD is another option.

Computer program products including non-transitory computer readable media that include instructions to enable computers to implement the disclosed techniques are also part of the disclosed teachings.

The disclosed teachings can easily be extended to an application involving authentication of a document. For example, a document template can be created based on the disclosed teachings. Such a document template can be used to compare further documents to determine the authenticity of the further documents Like in the case of test grading, a threshold comparison can be used to determine the authenticity. For example, if the comparison of the visual features is higher than a given threshold, then the document can be accepted as being authentic.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method for a document authoring tool, the method comprising:
determining a visual feature distribution of a document;
modifying the document by redistributing visual features of the document based on the visual feature distribution to create a modified document; and
generating a document template from the modified document.

2. The method of claim 1, further comprising:
aligning a marked up copy of the document template with the document template; and
extracting first markup from the marked up copy of the document template, based on the aligning.

3. The method of claim 2, further comprising comparing the marked up copy of the document template to a subsequent marked up copy of the document template.

4. The method of claim 3, wherein the comparing the marked up copy of the document template to the subsequent marked up copy of the document template comprises:
aligning the subsequent marked up copy of the document template with the document template; and
extracting second markup from the subsequent marked up copy of the document template, based on the aligning; and
comparing the extracted first markup with the extracted second markup.

5. The method of claim 3, further comprising:
generating a corrected version of the subsequent marked up copy of the document template by adding visual distinctions on the subsequent marked up copy of the document template, based on the comparing the marked up copy of the document template to the subsequent marked up copy of the document template.

6. The method of claim 1, wherein the redistributing is performed so that the visual features of the document are redistributed uniformly across the document.

7. The method of claim 1, wherein the redistribution is performed so that at least one figure is positioned based on a proximity of the figure to text relevant to the figure.

8. The method of claim 1, further comprising:
changing the visual features so as to further differentiate the document.

9. The method of claim 1, further comprising:
using the document template for comparing with a marked up document by a subprocess, including:
determining locations in the document template where correct markups are expected;
receiving a marked up document;
aligning the markedup document with the document template;
determining markup positions by comparing the marked up document and the document template;
making a determination regarding the markups based on the comparison if a percentage threshold of an expected markup is crossed.

10. The method of claim 9, wherein the threshold is 50%.

11. The method of claim 1, further comprising:
using the document template for comparing with a marked up document by a subprocess, including:
identifying a figure in the document template that is required to be compared;
receiving a markedup document with a corresponding figure;
aligning the markedup document with the document template; and
making a decision about the figure based a comparison of the figure in the document template and the corresponding figure in the markedup document.

12. The method of claim 11, wherein the determination is based on linear percentage.

13. The method of claim 11, wherein the determination is based on an area percentage.

14. A document authoring tool, the tool comprising:
an input that receives a document;
a visual features redistributor that redistributes visual features in the document;
a document modifier that modifies the document based on the redistributed visual features;
a document template generator that generates document template based on the modified document; and
an output.

15. A computer program product including a non-transitory computing medium, the medium having instructions to enable a computer to implement a method for a document authoring tool, the method comprising:
determining a visual feature distribution of a document;
modifying the document by redistributing visual features of the document based on the visual feature distribution to create a modified document; and
generating a document template from the modified document.
